(19) United States
(12) Patent Application Publication
(10) Pub. No.: US 2025/0339964 A1
(43) Pub. Date: Nov. 6, 2025

(54) TEACHING DEVICE AND COMPUTER PROGRAM

(71) Applicant: FANUC CORPORATION, Yamanashi (JP)

(72) Inventor: Kengo SHIMIZU, Yamanashi (JP)

(21) Appl. No.: 18/867,438

(22) PCT Filed: Jun. 29, 2022
(86) PCT No.: PCT/JP2022/026059

§ 371 Date: Nov. 20, 2024

(51) Int. Cl. B25J 9/16; G06F 16/9038; G06K 7/14

(52) U.S. Cl. CPC B25J 9/1656; G06F 16/9038; G06K 7/1417

(57) ABSTRACT

A teaching device for teaching industrial machinery, the teaching device including an image acquisition unit that acquires an image of a visually recognizable recognition target, a recognition unit that analyzes the acquired image and recognizes the recognition target, and a registration unit that, on the basis of a user operation, generates and saves correspondence information that associates the recognized recognition target and a program.

### FIELD

The present invention relates to a teaching device and a computer program.

### BACKGROUND

There are cases where, with progress of automation and manpower reduction in a plant, a multi-skilled worker capable of handling a plurality of processes performs a work in a plant. Each work process is often automated by introduction of industrial machines such as a robot and a machine tool, and the worker selects a relevant operation program by using a teach pendant to operate an industrial machine.

Regarding the above, PTL 1 describes as follows: “An operation panel with an NC function for machine tools includes an image capture device for reading a matrix-type two-dimensional code equipped on the front of the operation panel or on a manual pulse generator for hands-on operation connected to the operation panel, wherein a control unit inside the operation panel includes a reading unit processing image data of a matrix-type two-dimensional code captured by the image capture device and outputting the processed data as read data, and starts drive control on a machining unit, based on work instruction information included in the read data.” (ABSTRACT).

PTL 2 describes as follows: “An emergency stop switch including: a main switch unit being connected in a wired manner to a robot controller controlling drive of a robot and switching control of the robot controller to an emergency stop state in response to a user operation; an attaching unit detachably attaching the main switch unit to a mobile terminal accepting a user operation; and an identification code unit being provided at a position facing a lens of a camera included in a mobile terminal when the attaching unit is attached to the mobile terminal and displaying an identification code for identifying the main switch unit in such a manner as to allow an image of the identification code to be captured by the camera.” (ABSTRACT).

### CITATION LIST

### Patent Literature

[PTL 1] Japanese Unexamined Patent Publication (Kokai) No. 2017-227948 A
[PTL 2] Japanese Unexamined Patent Publication (Kokai) No. 2020-044625 A

### SUMMARY

### Technical Problem

When a worker selects an operation program to be executed on an industrial machine by operating a teach pendant, a problem arises that, with the increase of the number of registered operation programs, the time required for searching for an operation program increases and a human error, such as erroneous selection of an operation program, may occur. A teaching device and a computer program that enable a worker to easily and efficiently select an operation program to be executed on an industrial machine are desired.

### Solution to Problem

An aspect of the present disclosure is a teaching device used for teaching of an industrial machine, the teaching device including: an image acquisition unit configured to acquire a captured image of a visually recognizable recognition target; a recognition unit configured to recognize the recognition target by analyzing the acquired image; and a registration unit configured to generate and store, in accordance with a user operation, correspondence information associating the recognized recognition target with a program.

Another aspect of the present disclosure is a computer program for causing a processor in a computer to execute: a step of acquiring a captured image of a visually recognizable recognition target; a step of recognizing the recognition target by analyzing the acquired image; and a step of generating and storing, in accordance with a user operation, correspondence information associating the recognized recognition target with a program.

### Advantageous Effects of Invention

The aforementioned configurations enable easy and efficient selection of a program by a worker. Further, since any type of recognition target and a program can be registered in association with each other, a recognition target does not need to be newly generated on the user side.

The objects, the features, and the advantages of the present invention, and other objects, features, and advantages will become more apparent from the detailed description of typical embodiments of the present invention illustrated in accompanying drawings.

### BRIEF DESCRIPTION OF DRAWINGS

FIG. 1 is a diagram illustrating a configuration of a robot system including a teach pendant according to a first embodiment and functional blocks of the teach pendant.

FIG. 2 is a flowchart illustrating registration processing of an identification code according to the first embodiment.

FIG. 3 is a diagram illustrating an example of a reading/registration screen.

FIG. 4 is a diagram illustrating an example of a registration acceptance screen.

FIG. 5 is a flowchart illustrating reading processing of an identification code according to the first embodiment.

FIG. 6 is a diagram illustrating an example of the reading/registration screen.

FIG. 7A is a diagram illustrating an example of a notification screen when one program is registered.

FIG. 7B is a diagram illustrating an example of a registered program list screen.

FIG. 7C is a diagram illustrating an example of a notification screen when an identification code is not registered.

FIG. 8 is a diagram illustrating a configuration of a robot system including a teach pendant according to a second embodiment and functional blocks of the teach pendant.

FIG. 9 is a flowchart illustrating registration processing of an identification code according to the second embodiment.

FIG. 10 is a flowchart illustrating reading processing of an identification code according to the second embodiment.

### DESCRIPTION OF EMBODIMENTS

Next, embodiments of the present disclosure will be described with reference to drawings. In the referenced drawings, similar components or functional parts are given similar reference signs. For ease of understanding, the drawings use different scales as appropriate. Further, configurations illustrated in the drawings are examples for implementing the present invention, and the present invention is not limited to the illustrated configurations.

### First Embodiment

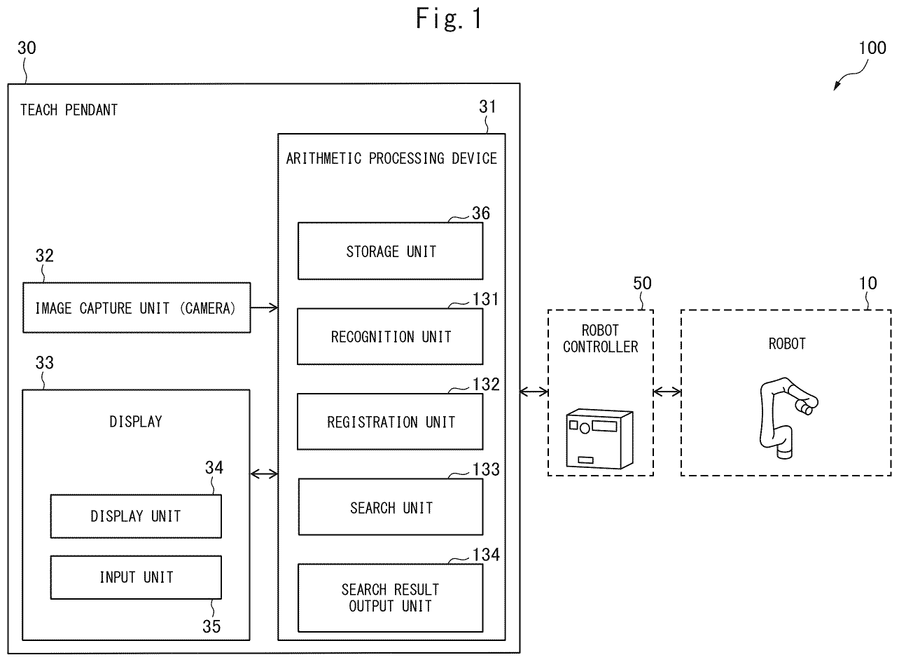

FIG. 1 illustrates a configuration of a robot system 100 including a teach pendant 30 according to a first embodiment and functional blocks of the teach pendant 30. As illustrated in FIG. 1, the robot system 100 according to the present embodiment includes the teach pendant (teaching device) 30, a robot controller 50, and a robot 10 controlled by the robot controller 50. The teach pendant 30 is connected to the robot controller 50. In the robot system 100 with such a configuration, various types of robots, such as an articulated robot, a parallel link robot, and a dual-arm robot, may be used as the robot 10 depending on a work target. The robot controller 50 controls the robot 10 in accordance with an instruction from the teach pendant 30, or an operation program (hereinafter described as a “program”). The teach pendant 30 provides various functions for performing teaching of the robot 10. The teach pendant 30 may be configured by using an information processing device such as a tablet terminal.

The teach pendant 30 according to the present embodiment provides a registration function of reading any type of identification code by using a camera and registering the read identification code in association with a robot program. Furthermore, by reading an identification code affixed to, for example, a workpiece by using the camera, the teach pendant 30 can provide a function of selecting and executing a program registered in association with the identification code.

As illustrated in FIG. 1, the teach pendant 30 includes an arithmetic processing device 31, an image capture unit 32, and a display 33.

The arithmetic processing device 31 is a processing device including a processor and a memory (storage unit 36).

As an example, the image capture unit 32 includes a built-in camera and provides a function of acquiring an image of a target object captured by the built-in camera. The image capture unit 32 may be configured to acquire an image captured by an external camera. The function of the image capture unit 32 may be described as an image acquisition unit acquiring a captured image of a target object.

The display 33 includes a display unit 34 and an input unit 35. For example, the display unit 34 is a flat display panel, and the input unit 35 is a touch panel integrated with the display panel.

The arithmetic processing device 31 includes a recognition unit 131, a registration unit 132, a search unit 133, and a search result output unit 134. The functional blocks may be provided by executing software by the processor in the arithmetic processing device 31.

By analyzing a captured image of an identification code, wherein the image is acquired by the image capture unit 32, the recognition unit 131 recognizes an identification code in the image.

Various codes including a one-dimensional code and a two-dimensional code may be used as an identification code. By image analysis, a code provides information coded in the code (a coded pattern) as decoded information.

The registration unit 132 provides a function of registering a recognized identification code in association with a robot program. The registration unit 132 generates a correspondence table (correspondence information) associating an identification code with a program and stores the table into the storage unit 36.

The search unit 133 provides a function of searching the correspondence table for an identification code recognized through the recognition unit 131 and specifying a program corresponding to the recognized identification code.

The search result output unit 134 provides a function of outputting a search result to the display unit 34, accepting a user operation for selecting a program from among a plurality of retrieved programs, etc. The search result output unit 134 may be further configured to instruct the robot controller 50 to execute a program automatically selected or user selected as a program corresponding to an identification code.

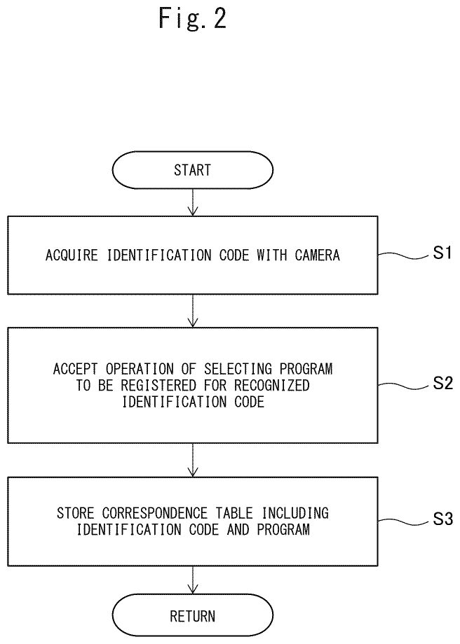

Registration processing enabling registration of any type of identification code in the teach pendant 30 will be described with reference to FIG. 2 to FIG. 4. FIG. 2 is a flowchart illustrating the registration processing of an identification code.

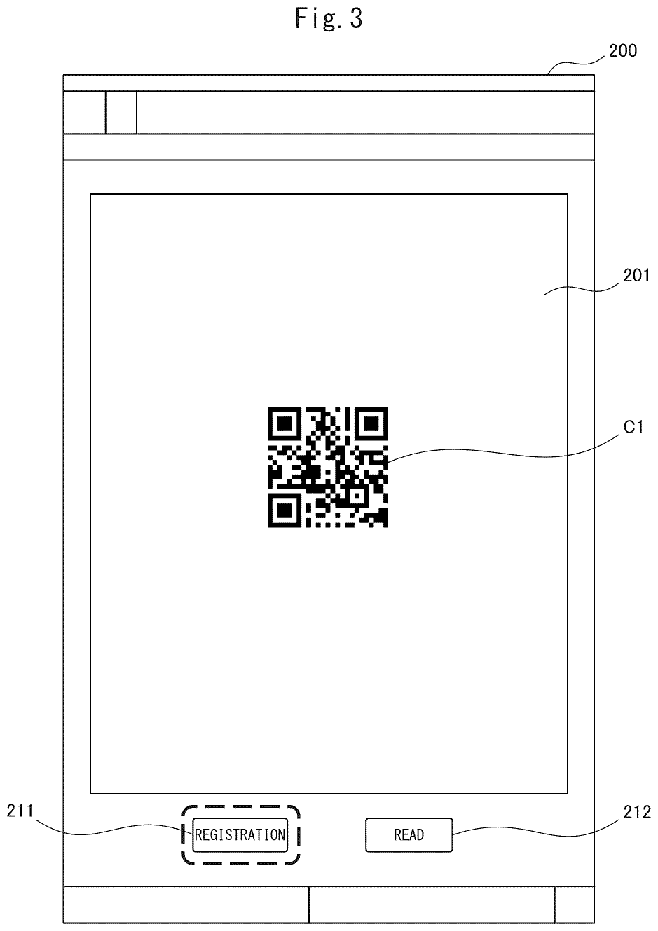

First, a user acquires an identification code intended to be associated with a program by capturing an image of the identification code with the image capture unit (camera) 32 of the teach pendant 30 (step S1). Acquiring an identification code specifically means acquiring information indicated by the identification code. In step S1, by performing a predetermined operation through the input unit 35, the user starts a reading/registration screen 200 for reading and registering an identification code as illustrated in FIG. 3. FIG. 3 illustrates an example of the reading/registration screen 200.

As illustrated in FIG. 3, the reading/registration screen 200 includes an area where a camera image (live image) 201 is displayed. A registration button 211 for registering an identification code and a read button 212 are arranged below the camera image 201.

The registration button 211 is used for starting processing of recognizing an identification code C1 appearing in the camera image 201 and registering the code in association with a program. The read button 212 is a button for starting reading processing to be described later.

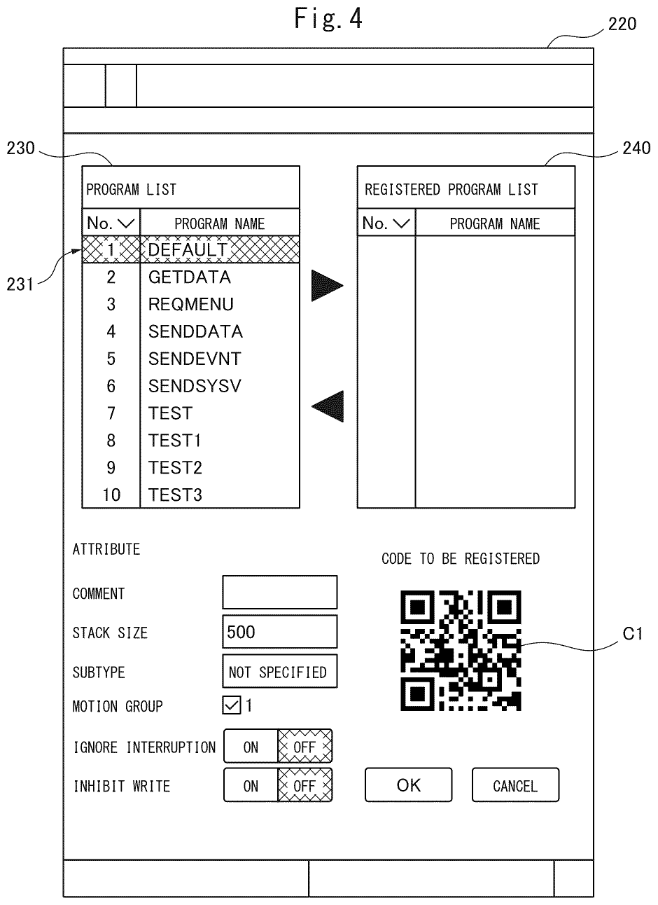

The registration button 211 is tapped in a state of the identification code C1 being displayed in the camera image 201 as illustrated in FIG. 3. Consequently, the processing advances from step S1 to step S2, a registration acceptance screen 220 illustrated in FIG. 4 is displayed, and an operation of selecting a program to be registered for the recognized identification code is accepted.

The registration acceptance screen 220 includes a program list display area 230 for displaying a program list registered in the robot controller 50 and a registered program list display area 240 for displaying a list of programs associated with the identification code C1 being the current registration target. FIG. 4 shows a state where the user selects a first program “DEFAULT”. By completion of the selection operation, the program “DEFAULT” is displayed in the registered program list display area 240 as a program corresponding to the identification code C1. A plurality of programs may be registered for one identification code in the registration acceptance screen 220.

Through the registration processing as described above, an identification code and a program are registered in the teach pendant 30 in association with each other. The teach pendant 30 (registration unit 132) generates a correspondence table associating a recognized identification code with a program and stores the table into the storage unit 36.

Thus, a user can register any type of identification code and one or a plurality of programs in association with each other, according to the present embodiment. A remarkable point is that, since any type of identification code can be associated with a program, the user does not necessarily newly generate an identification code and, for example, can register various existing identification codes in association with programs.

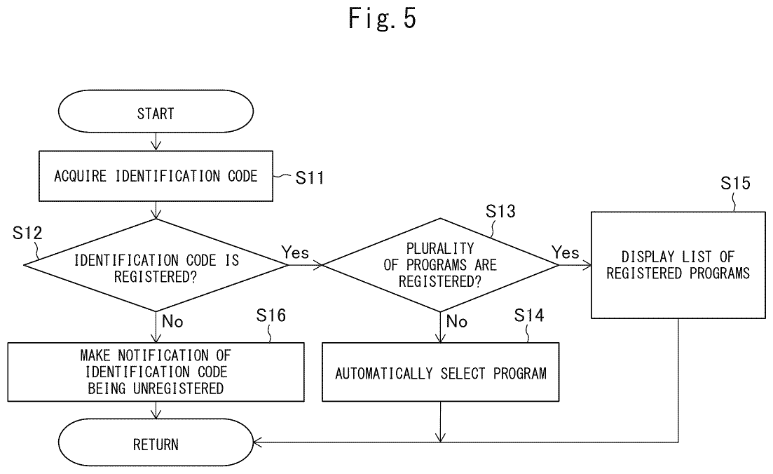

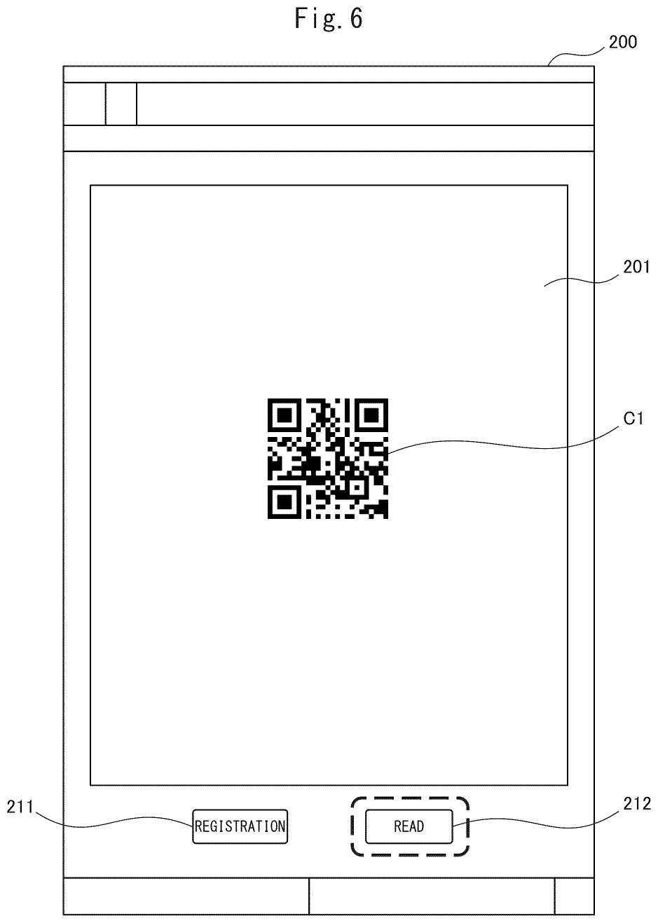

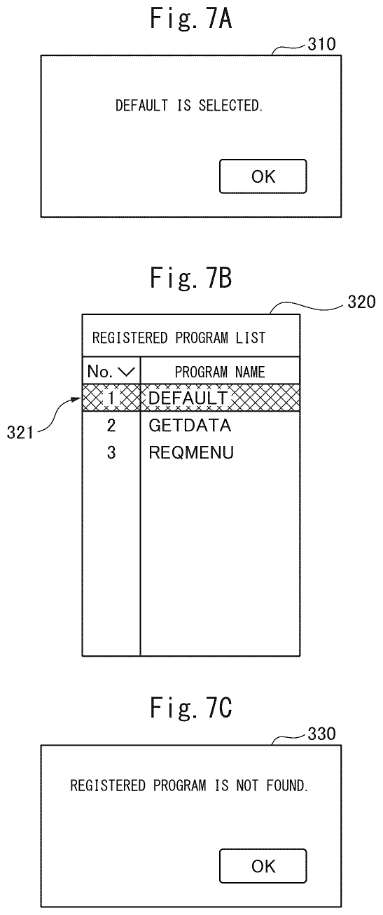

Next, a flow of the reading processing of an identification code will be described with reference to a flowchart in FIG. 5, FIG. 6, and FIG. 7A to FIG. 7C. When the reading processing is started, a reading/registration screen 200 illustrated in FIG. 6 is started and is displayed on the display unit 34. An image of an identification code C1 captured by a user with the image capture unit 32 appears in a camera image 201 on the reading/registration screen 200. The user taps the read button 212 on the reading/registration screen 200 in FIG. 6. Consequently, the identification code C1 appearing in the camera image 201 is analyzed by the recognition unit 131, and the identification code C1 is acquired (step S11).

Next, the search unit 133 checks the previously registered correspondence table against the identification code acquired in step S11 so as to confirm registration status of a program related to the acquired identification code. In step S12, the search unit 133 confirms whether the acquired identification code is registered (i.e., whether the acquired identification code is registered in the correspondence table in association with a program). When the identification code is registered (S12: Yes), the processing advances to step S13, and the search unit 133 further determines whether a plurality of programs are registered in association with the acquired identification code (step S13).

When a plurality of programs are registered in association with the identification code (S13: Yes), the search result output unit 134 displays a list of the plurality of registered programs (step S15). FIG. 7B illustrates an example of a registered program list screen 320 displayed in step S15. A state of three programs (“DEFAULT,” “GETDATA,” and “REQMENU”) being registered in association with the identification code acquired in step S11 is illustrated on the registered program list screen 320 in FIG. 7B. The search result output unit 134 may accept a user operation of selecting a program from the registered program list screen 320.

When one program is registered in association with the acquired identification code (S13: No), the search result output unit 134 automatically selects the one registered program (step S14). FIG. 7A illustrates an example of a notification screen 310 displayed on the display unit 34 in this case. Automatic selection of the program “DEFAULT” is displayed on the notification screen 310.

When the identification code is determined not to be registered (i.e., the acquired identification code is not associated with a program) in step S12 (S12: No), the search result output unit 134 makes notification of the identification code not being registered (step S16). FIG. 7C illustrates an example of a notification screen 330 when the identification code is not registered.

The teach pendant 30 (arithmetic processing device 31) may operate in such a way as to cause the robot controller 50 to execute the automatically selected or user-selected program in response to completion of the reading processing.

Thus, according to the present embodiment, a worker can select and execute a program by performing a simple and easy operation of reading an identification code by using a teach pendant. Accordingly, selection of a program by the worker becomes easy and efficient.

According to the present embodiment, a user can register any code as a code for identifying a program by the registration processing described above. Accordingly, the user does not necessarily need to newly generate an identification code related to a program. For example, a barcode attached to a product, a barcode on an employee identification card, a two-dimensional code on a weblink, etc. can be used as an identification code. The user may newly create a code (such as a barcode).

The property allowing use of any code as a code for specifying a program brings significant advantages to a user, such as saving or shortening time and effort for generating an identification code and providing a broader range of code selections.

Applications of the present embodiment in regard to what type of target an identification code is to be associated with may include an example of associating the identification code with a workpiece, an example of associating the identification code with a worker, and an example of associating the identification code with a workplace.

In the example of associating an identification code with a workpiece, one or a plurality of programs handling a certain workpiece are registered in association with an identification code. For example, the identification code may be affixed to the workpiece. Even when one robot handles a wide variety of workpieces, a program handling the workpiece is automatically selected or can be selected from a list of programs handling the workpiece by reading the identification code. Accordingly, the program can be efficiently applied to the robot system.

In the example of associating an identification code with a worker, one or a plurality of programs used by a certain worker in a work process on the day are registered in association with an identification code. For example, it is assumed that the identification code is an employee identification card carried by the worker. For example, registration of a program for the identification code in this case is performed by a manager managing the entire process. The worker himself or herself performs work of reading the identification code. By merely performing the work of reading an employee code as the identification code by the worker, a program to be executed by the worker is automatically selected or can be selected from a list. Accordingly, the program can be efficiently applied to the robot system.

In the example of associating an identification code with a workplace, one or a plurality of programs to be executed at a certain workplace are registered in association with an identification code. For example, the identification code is placed in the workplace in a state of being printed on a print medium or being displayed on a display device. Consequently, by performing work of reading the identification code by the worker, a program to be executed at the workplace is automatically selected or can be selected from a list and can be executed by the worker. Even in a situation of changing a worker, the worker after the change does not waver in selection of a program. Accordingly, the program can be efficiently applied to the robot system.

### Second Embodiment

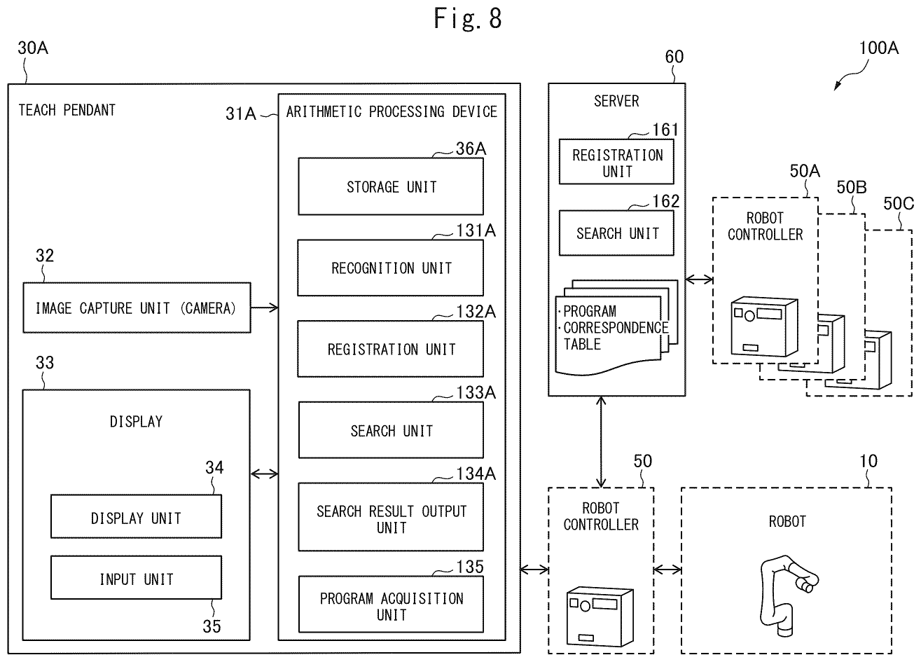

A teach pendant and a robot system according to a second embodiment will be described below. FIG. 8 illustrates a configuration of a robot system 100A including a teach pendant 30A according to the second embodiment. FIG. 8 also illustrates functional blocks. In FIG. 8, a component being the same as a component according to the first embodiment in FIG. 1 is given the same sign.

As illustrated in FIG. 8, the robot system 100A includes the teach pendant 30A, a robot controller 50, and a robot 10 controlled by the robot controller 50. Furthermore, the robot system 100A includes a server 60 connected to the robot controller 50. The server 60 is also connected to robot controllers 50A, 50B, and 50C related to other robot systems. The server 60 in the robot system 100A holds and manages a robot program and a correspondence table associating an identification code with the program. The teach pendant 30A provides the correspondence table associating an identification code with a program to the server 60 so as to register the correspondence table in the server 60. Robot programs are registered and centrally managed in the server 60. The teach pendant 30A causes the server 60 to execute a search for a program based on an identification code and acquires the search result from the server 60.

As illustrated in FIG. 8, an arithmetic processing device 31A in the teach pendant 30A is a processing device including a processor and a memory (storage unit 36A).

The arithmetic processing device 31A further includes a recognition unit 131A, a registration unit 132A, a search unit 133A, a search result output unit 134A, and a program acquisition unit 135. The functional blocks may be provided by executing software by the processor in the arithmetic processing device 31A.

By analyzing a captured image of an identification code, wherein the image is acquired by the image capture unit 32, the recognition unit 131A recognizes the identification code in the image.

The registration unit 132A provides a function of registering a recognized identification code in association with a robot program. The registration unit 132 transmits a correspondence table associating an identification code with a program to the server 60 so as to register the table in the server 60.

By sending an identification code recognized through the recognition unit 131A to the server 60, the search unit 133A causes the server 60 to execute a search for a program corresponding to the identification code and acquires the search result.

The search result output unit 134A provides a function of displaying a search result on a display unit 34, accepting a user operation of selecting a program from among a plurality of retrieved programs, etc. The search result output unit 134A can instruct the robot controller 50 to execute a registered program automatically selected or user selected as a program corresponding to an identification code.

The program acquisition unit 135 provides a function of, for example, when a program associated with an identification code does not exist in the robot controller 50, acquiring the program from the server 60.

As illustrated in FIG. 8, the server 60 includes a registration unit 161 having a function of storing a correspondence table transmitted from the teach pendant 30A into a storage device in the server 60. The server 60 further includes a search unit 162 having a function of, in response to a request from the teach pendant 30A, searching for a program associated with an identification code by using the correspondence table. The search unit 162 provides the search result to the teach pendant 30A.

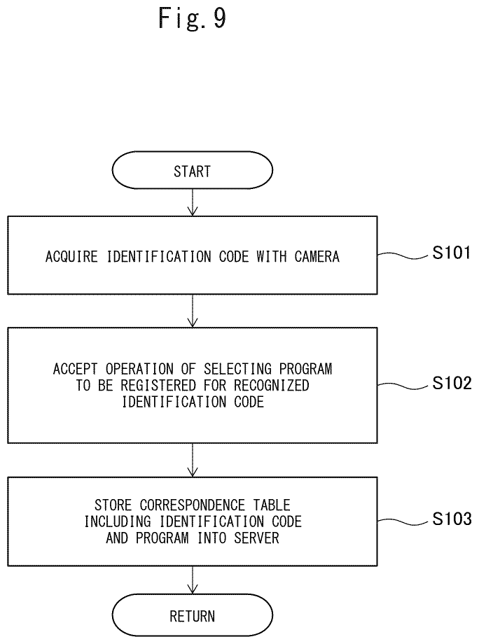

FIG. 9 is a flowchart illustrating a flow of registration processing for registering any type of identification code in the robot system 100A. First, a user acquires an identification code intended to be associated with a program by capturing an image of the identification code with the image capture unit (camera) 32 of the teach pendant 30A (step S101). Acquisition of the identification code is performed through the reading/registration screen 200 illustrated in FIG. 3.

Next, the registration unit 132A accepts a user operation of selecting a program to be registered in association with the recognized identification code (step S102). The user can select a program to be associated with the identification code and register the identification code through the registration acceptance screen 220 as illustrated in FIG. 4.

Next, the registration unit 132A creates a correspondence table including an identification code and a program registered in association with the identification code and stores data of the correspondence table into the server 60 through the robot controller 50 (step S103). The registration unit 161 in the server 60 stores the correspondence table received from the teach pendant 30A into the storage device in the server 60.

An identification code and a program are registered in the server 60 in association with each other through the registration processing as described above.

Thus, a user can register any type of identification code and one or a plurality of programs in association with each other, according to the present embodiment as well. Since any type of identification code can be associated with a program, a user does not necessarily newly generate an identification code and, for example, can register various existing codes in association with programs.

Since the server 60 is also connected to the robot controllers 50A, 50B, and 50C for other robot systems as illustrated in FIG. 8, a correspondence table including an identification code and a program generated through the registration processing as described above in another robot system can also be registered in the server 60. The server 60 (registration unit 161) can centrally manage correspondence tables including a correspondence table transmitted from another robot system. As an example, the server 60 (registration unit 161) may combine correspondence tables sent from the robot controllers (50, 50A, 50B, and 50C) into one correspondence table and manage the combined table. In this case, a correspondence table registered in the server 60 by another robot system can be used in the robot system 100.

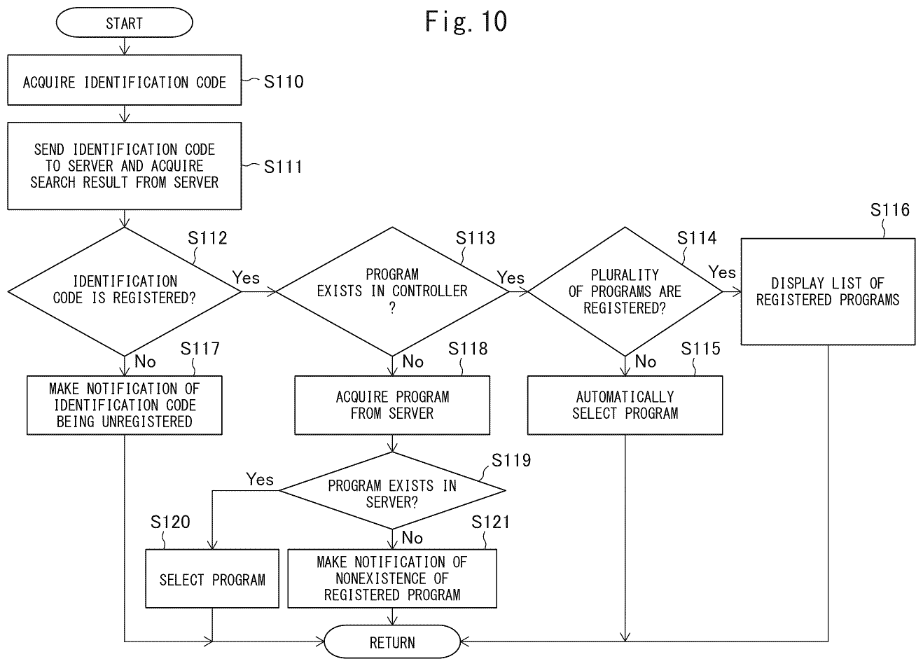

Next, a flow of processing of reading an identification code will be described with reference to a flowchart in FIG. 10. When the processing is started, the reading/registration screen 200 as illustrated in FIG. 6 is started and is displayed on the display unit 34. As described above in relation to FIG. 6, a user taps the read button 212 in a state where an image of the identification code C1 captured by the image capture unit 32 appears in the camera image 201 on the reading/registration screen 200. Consequently, the identification code C1 appearing in the camera image 201 is analyzed and acquired by the recognition unit 131 (step S110).

The search unit 133A causes the server 60 (search unit 162) to execute a search for a program registered in association with the acquired identification code by transmitting the identification code to the server 60, acquires the search result, and confirms the registration status (step 111).

Presentation of the search result is performed by the search result output unit 134A in a series of processing operations in steps S112 to S121. Presentation modes of the search result in this case are described below.
(1) When one program is registered in relation to the identification code: automatically select the registered program.
(2) When a plurality of programs are registered in relation to the identification code: display a list of programs registered in association with the identification code and accept a user operation of selecting a program from the list.
(3) When the identification code is unregistered, make notification of the status.
(4) When a program associated with the identification code does not exist in the robot controller 50: acquire the program from the server 60.
(5) When a program associated with the identification code does not exist in the robot controller 50 or the server 60: make notification of nonexistence of a program associated with the identification code.

In step S112, the search unit 133A confirms whether the acquired identification code is registered (i.e., whether the acquired identification code is registered in association with a program in the correspondence table). When the identification code is registered (S112: Yes), the processing advances to step S113.

In step S113, the search unit 133A determines whether a program associated with the identification code exists in the robot controller 50. When a program related to the identification code exists in the robot controller 50 (S113: Yes), the processing advances to step S114, and the search unit 133A further determines whether a plurality of programs are registered in association with the acquired identification code (step S114).

When a plurality of programs are registered in association with the identification code (S114: Yes), the search result output unit 134A displays a list of registered programs (step S116). The displayed program list screen may have a content similar to that of the registered program list screen 320 illustrated in FIG. 7B.

When one program is registered in association with the acquired identification code (S114: No), the search result output unit 134A automatically selects the registered program (step S115). A screen notified in this case may have a content similar to that of the notification screen 310 illustrated in FIG. 7A.

When the identification code is determined to be unregistered in step S112 (S112: No), the search result output unit 134A makes notification of the acquired identification code being unregistered (step S117). A screen with a content similar to that of the notification screen 330 illustrated in FIG. 7C may be displayed on the display unit 34.

When a program registered in association with the identification code is determined not to exist in the robot controller 50 in step S113 (S112: No), the program acquisition unit 135 operates in such a way as to acquire the program from the server 60 (step S118).

When, as a result, the program is successfully acquired from the server 60 (S119: Yes), the search unit 133A selects the program acquired from the server as a program being an execution target (step S120).

When the program is not registered in the server 60 either (S119: No), the search result output unit 134A displays an image indicating that the program does not exist in the robot controller 50 or the server 60 on the display unit 34 (step S121).

The configuration of the robot system 100A according to the second embodiment as described above can provide the following advantages in addition to various advantages described in the first embodiment.
(1) Even when the robot controller 50 does not hold a program, the program can be downloaded from the server 60 and be executed in the robot system 100A. Accordingly, the size of a memory for storing programs in the robot controller can be reduced.
(2) Since the correspondence table is managed by the server 60, the correspondence table can be updated from the teach pendant or another information processing device. In this case, time and effort for creating and updating the correspondence table in each robot system can be saved.
(3) Since a program can be automatically downloaded from the server and be executed, manual loading of a program when, for example, the robot is replaced is not necessary. In this case, a user can cause the robot to execute the program merely by performing work of reading an identification code, and therefore, start-up of a robot after the robot replacement is facilitated. Further, the robot system can be suitably used in fields in which a robot is frequently moved, such as low-volume and multi-product production.
(4) A program can be downloaded from the server and be executed in each robot system, and therefore, when the program is to be modified, a modified program can be applied to each robot system by uploading the modified program to the server 60. Accordingly, maintenance of programs is facilitated.

As described above, each embodiment provides easy and efficient selection of a program by a worker. Since any type of recognition target can be registered in association with a program, an identification code does not need to be generated on the user side.

While the present invention has been described above by using the typical embodiments, it may be understood by a person skilled in the art that changes, and various other changes, omissions, and additions can be made to the aforementioned embodiments without departing from the scope of the present invention.

While an example of using an identification code as a recognition target associated with a program in the registration processing has been described in the aforementioned embodiments, an object with a certain visually recognizable characteristic, such as a figure or a symbol, may be applied as a recognition target in place of an identification code. For example, an array of several relatively simple figures (such as triangles or circles) may be employed as a recognition target.

The configurations according to the aforementioned embodiments can be applied not only to a robot system but also to selection of a program in a system including various industrial machines such as a machine tool.

The robot controller 50 may have a configuration as a common computer including a CPU, a ROM, a RAM, a storage device, an operation unit, a display unit, an input-output interface, a network interface, etc.

The server 60 may have a configuration as a common computer including a CPU, a ROM, a RAM, a storage device, an operation unit, a display unit, an input-output interface, a network interface, etc.

A computer program executing the registration processing (FIG. 2 and FIG. 9) and the reading processing (FIG. 5 and FIG. 10) according to the embodiments described above can be recorded on various computer-readable recording media (such as semiconductor memories such as a ROM, an EEPROM, and a flash memory; a magnetic recording medium; and optical disks such as a CD-ROM and a DVD-ROM).

### REFERENCE SIGNS LIST

10 Robot
30 Teach pendant
31 Arithmetic processing device
32 Image capture unit
33 Display
34 Display unit
35 Input unit
36, 36A Storage unit
50, 50A, 50B, 50C Robot controller
100, 100A Robot system
131, 131A Recognition unit
132, 132A Registration unit
133, 133A Search unit
134, 134A Search result output unit
161 Registration unit
162 Search unit
200 Reading/registration screen
220 Registration acceptance screen
310 Notification screen
320 Registered program list screen
330 Notification screen

1. A teaching device used for teaching of an industrial machine, the teaching device comprising:
an image acquisition unit configured to acquire a captured image of a visually recognizable recognition target;
a recognition unit configured to recognize the recognition target by analyzing the acquired image; and
a registration unit configured to generate and store, in accordance with a user operation, correspondence information associating the recognized recognition target with a program.

2. The teaching device according to claim 1, wherein
the recognition target is an identification code.

3. The teaching device according to claim 1, wherein
the registration unit stores the correspondence information into a storage unit in the teaching device.

4. The teaching device according to claim 3, further comprising:
a search unit configured to search for, by using the correspondence information, a program corresponding to the recognition target recognized by the recognition unit; and
a search result output unit configured to output a search result by the search unit.

5. The teaching device according to claim 1, wherein
the registration unit transmits the correspondence information to an external server and causes the server to store the correspondence information.

6. The teaching device according to claim 5, further comprising:
a search unit configured to transmit information indicating the recognition target recognized by the recognition unit to the server and acquire, from the server, a search result of searching for, in the server, a program corresponding to the recognition target by using the correspondence information; and
a search result output unit configured to output the search result by the search unit.

7. The teaching device according to claim 4, wherein,
when, as the search result, one program corresponding to the recognized recognition target is retrieved, the search result output unit automatically selects the one retrieved program as a program to be executed.

8. The teaching device according to claim 4, wherein,
when, as the search result, a plurality of programs corresponding to the recognized recognition target are retrieved, the search result output unit displays a list of a plurality of retrieved programs on a display unit and accepts an operation for selecting one program from the list.

9. The teaching device according to claim 4, wherein,
when a program related to the recognized recognition target is not retrieved, the search result output unit displays, on a display unit, information indicating that a program corresponding to the recognition target is not registered.

10. The teaching device according to claim 6, further comprising
a program acquisition unit configured to acquire a program corresponding to the recognition target from the server when a program corresponding to the recognition target retrieved by the search unit does not exist in a robot controller connected to the teaching device.

11. The teaching device according to claim 4, wherein
one or a plurality of programs handling a specific workpiece are associated with the recognition target in the correspondence information.

12. The teaching device according to claim 4, wherein
one or a plurality of programs used in a work process on a specific day are associated with the recognition target in the correspondence information.

13. The teaching device according to claim 4, wherein
one or a plurality of programs to be executed at a specific workplace are associated with the recognition target in the correspondence information.

14. A non-transitory computer readable storage medium storing instructions that, when executed by a processor of a computer, cause the processor to perform:
acquiring a captured image of a visually recognizable recognition target;
recognizing the recognition target by analyzing the acquired image; and
generating and storing, in accordance with a user operation, correspondence information associating the recognized recognition target with a program.

15. The non-transitory computer readable storage medium according to claim 14, the instructions further causing the processor to perform:
storing the correspondence information into a storage unit in the computer in the generating and storing the correspondence information;
searching for a program corresponding to the recognized recognition target by using the correspondence information; and
outputting a result of the searching.

16. The non-transitory computer readable storage medium according to claim 14, the instructions further causing the processor to perform:
transmitting the correspondence information to an external server and causing the server to store the correspondence information in the generating and storing the correspondence information;
transmitting information indicating the recognized recognition target to the server and acquiring, from the server, a search result of searching for, in the server, a program corresponding to the recognition target by using the correspondence information; and
outputting the acquired search result.
